(19) United States
(12) Patent Application Publication
(10) Pub. No.: US 2019/0152866 A1
(43) Pub. Date: May 23, 2019

(54) COATING APPARATUS AND COATING METHOD

(71) Applicant: MITSUBISHI HEAVY INDUSTRIES, LTD., Tokyo (JP)

(72) Inventors: Takumi BOHNO, Tokyo (JP); Shuji TANIGAWA, Tokyo (JP); Masahiko MEGA, Tokyo (JP)

(21) Appl. No.: 16/197,806

(22) Filed: Nov. 21, 2018

(30) Foreign Application Priority Data
Nov. 22, 2017 (JP) 2017-224418

(51) Int. Cl. C04B 35/628; B05C 19/00; B05C 19/04; B05D 1/12; B28B 17/02; C04B 35/48; C04B 35/632; C23C 24/04; C23C 24/10

(52) U.S. Cl. CPC C04B 35/62802; B05C 19/008; B05C 19/04; B05D 1/12; B28B 17/026; C04B 2235/5436; C04B 35/632; C23C 24/04; C23C 24/10; C04B 2235/3246; C04B 35/48

(57) ABSTRACT

A coating apparatus is provided that includes: a mixer configured to generate mixed ceramic powder in which a material which contains an organic compound imparting lubricity to raw ceramic powder whose average particle size is smaller than or equal to 10 μm and acts as an additive is mixed into the raw ceramic powder; a jetting device configured to jet the mixed ceramic powder toward a surface of a base material; and a heating device configured to heat the mixed ceramic powder jetted from the jetting device, and to evaporate the organic compound of the additive contained in the mixed ceramic powder.

### CROSS-REFERENCE TO RELATED APPLICATION

Priority is claimed on Japanese Patent Application No. 2017-224418, filed Nov. 22, 2017, the content of which is incorporated herein by reference.

### BACKGROUND

This invention relates to a coating apparatus and a coating method.

As a method of forming a ceramic coating on a base material, for example, methods of causing a raw ceramic powder to collide with the base material at a high speed without melting the raw ceramic powder such as an aerosol deposition method (also referred to as AD method), a cold spray method, and so on are known.

In Patent Document 1, a technique for forming zirconia minute particles that are a raw powder into a coating using an AD method is disclosed.

In Patent Document 2, a technique for forming a zirconium oxide material into a coating using a cold spray apparatus is disclosed.

[Patent Document 1] Japanese Unexamined Patent Application, First Publication No. 2011-102428

[Patent Document 2] Japanese Unexamined Patent Application, First Publication No. 2016-199783

### SUMMARY

A raw ceramic powder whose average particle size is small may be used to form a dense coating using a coating method such as the AD method disclosed in Patent Document 1 or the cold spray method disclosed in Patent Document 2. However, when the raw ceramic powder whose average particle size is smaller than or equal to 10 μm is used, a cohesive property of the raw ceramic powder may be increased, and the raw ceramic powder may cohere inside the apparatus.

To prevent cohesion of this raw ceramic powder, for example, there is a method of mixing an additive such as a dispersant for inhibiting the cohesion into the raw ceramic powder. However, when this additive is mixed into the raw ceramic powder, there is a problem in that the additive as a foreign substance is contained in the formed coating, and quality of the coating is deteriorated.

This invention was made in view of these conventional circumstances, and is directed to providing a coating apparatus and a coating method capable of improving the quality of a coating while inhibiting cohesion of a raw ceramic powder.

To solve the above problem, this invention adopts the following constitutions.

According to a first aspect of this invention, a coating apparatus includes: a mixer configured to generate a mixed ceramic powder in which a material containing an organic compound that imparts lubricity to a raw ceramic powder whose average particle size is smaller than or equal to 10 μm and acting as an additive is mixed into the raw ceramic powder; a jetting device configured to jet the mixed ceramic powder toward a surface of a base material; and a heating device configured to heat the mixed ceramic powder jetted from the jetting device, and to evaporate the organic compound of the additive contained in the mixed ceramic powder.

With this constitution, in the case where the raw ceramic powder whose average particle size is smaller than or equal to 10 μm is used, lubricity can be imparted to the raw ceramic powder by the additive. For this reason, cohesion of the mixed ceramic powder in which the additive is mixed into the raw ceramic powder can be inhibited. Furthermore, since the organic compound of the additive contained in the mixed ceramic powder jetted from the jetting device can be evaporated by the heating device, the organic compound can be inhibited from being contained in the ceramic coating formed on the surface of the base material.

Therefore, the quality of the coating can be improved while inhibiting cohesion of the raw ceramic powder.

According to a second aspect of this invention, the heating device according to the first aspect may heat the mixed ceramic powder jetted toward the surface of the base material by the jetting device before the jetted mixed ceramic powder reaches the surface of the base material, and evaporate the organic compound of the additive contained in the mixed ceramic powder.

According to a third aspect of this invention, an average particle size of the additive according to the first or second aspect may be smaller than or equal to 10 nm.

With this constitution, the lubricity imparted by the additive can be further improved.

According to a fourth aspect of this invention, the raw ceramic powder according to the third aspect may contain at least yttria-stabilized zirconia.

With this constitution, the quality of the coating containing the yttria-stabilized zirconia can be improved.

According to a fifth aspect of this invention, the additive according to the third or fourth aspect may contain globular silica and the organic compound provided on a surface of the globular silica.

With this constitution, lubricity can be imparted by the organic compound. Furthermore, since the organic compound is formed on the surface of the globular silica, a percentage at which the organic compound is contained in the additive can be made smaller than the case where the entire additive is the organic compound. Therefore, the additive can be easily evaporated by the heating device.

According to a sixth aspect of this invention, the organic compound according to the fifth aspect may be phenylsilane, and the additive may be formed by surface-treating the phenylsilane on the globular silica through a coupling reaction.

With this constitution, lubricity can be imparted by the phenylsilane. Furthermore, since the phenylsilane is formed on the surface of the globular silica, a percentage at which the phenylsilane is contained in the additive can be made smaller than the case where the entire additive is the phenylsilane. Therefore, the additive can be easily evaporated by the heating device.

According to a seventh aspect of this invention, a coating method includes: a mixed ceramic powder-generating process of mixing a material containing an organic compound that imparts lubricity and acting as an additive into a raw ceramic powder whose average particle size is smaller than or equal to 10 μm to generate a mixed ceramic powder; and a jet evaporating process of jetting the mixed ceramic powder toward a surface of a base material, and heating the jetted mixed ceramic powder to evaporate the organic compound contained in the additive.

With this constitution, in the case where the raw ceramic powder whose average particle size is smaller than or equal to 10 μm is used, lubricity can be imparted to the raw ceramic powder by the additive. For this reason, cohesion of the mixed ceramic powder in which the additive is mixed into the raw ceramic powder can be inhibited. Furthermore, since the mixed ceramic powder is jetted and the organic compound of the additive can be evaporated, the organic compound can be inhibited from being contained in the ceramic coating formed on the surface of the base material.

Therefore, the quality of the coating can be improved while inhibiting cohesion of the raw ceramic powder.

According to an eighth aspect of this invention, the raw ceramic powder according to the seventh aspect may contain at least yttria-stabilized zirconia.

According to a ninth aspect of this invention, the additive according to the seventh aspect may be phenylsilane, and the additive may be formed by surface-treating the phenylsilane on the globular silica through a coupling reaction.

According to a tenth aspect of this invention, the organic compound according to the ninth aspect may be phenylsilane, and the additive may be formed by surface-treating the phenylsilane on the globular silica through a coupling reaction.

According to an eleventh aspect of this invention, a coating method includes: mixing a material containing an organic compound that imparts lubricity and acting as an additive into a raw ceramic powder whose average particle size is smaller than or equal to 10 μm to generate a mixed ceramic powder; jetting the mixed ceramic powder toward a surface of a base material; heating the jetted mixed ceramic powder before the jetted mixed ceramic powder reaches the base material; evaporating and removing the organic compound contained in the additive of the mixed ceramic powder before the mixed ceramic powder reaches the base material; and causing the mixed ceramic powder from which the organic compound is removed to collide with the base material to form a coating.

According to the coating apparatus and the coating method, the quality of the coating can be improved while inhibiting cohesion of the ceramic powder serving as a raw material.

### BRIEF DESCRIPTION OF THE DRAWINGS

FIG. 1 is a constitution diagram illustrating a schematic constitution of a coating apparatus according to a first embodiment of this invention.

FIG. 2 is a graph illustrating adhesive forces of a raw ceramic powder P1 and a mixed ceramic powder P3 in the first embodiment of this invention.

FIG. 3 is a flow chart of a coating method in the first embodiment of this invention.

FIG. 4 is a flow chart illustrating details of a jet evaporating process in the first embodiment of this invention.

FIG. 5 is a graph whose vertical axes indicate interfacial strain (%) and coating efficiency (vs 0 wt %) and whose horizontal axis indicates an additive rate (wt %) of the additive added to the mixed ceramic powder.

FIG. 6 is a graph whose vertical axes indicate interfacial strain (%) and adhesive force (kPa) and whose horizontal axis indicates an additive rate (wt %) of the additive added to the mixed ceramic powder.

FIG. 7 is a graph whose vertical axis indicates shear stress (kPa) and whose horizontal axis indicates a load (kPa).

### DETAILED DESCRIPTION OF EMBODIMENTS

Next, a coating apparatus in a first embodiment of this invention will be described with reference to the drawings. In the first embodiment, the coating apparatus for forming a coating using a cold spray method will be described by way of example.

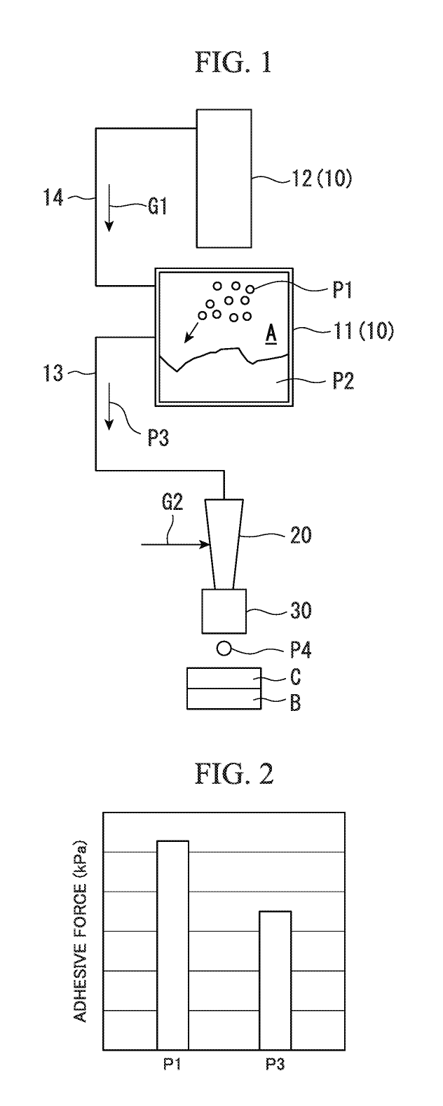

FIG. 1 is a constitution diagram illustrating a schematic constitution of a coating apparatus of the first embodiment.

As illustrated in FIG. 1, the coating apparatus 100 in the first embodiment includes a powder supply device 10, a jetting device 20, and a heating device 30.

The powder supply device 10 supplies a mixed ceramic powder P3 in which a raw ceramic powder P1 and an additive P2 are mixed to a jetting device 20. The powder supply device 10 includes a mixer 11 and a carrier gas supply unit 12.

The mixer 11 mixes the additive P2 with the raw ceramic powder P1, and generates the mixed ceramic powder P3. The mixer 11 has an internal space A that can contain the raw ceramic powder P1 and the additive P2, and can agitate the powder contained in the internal space A. Further, the mixer 11 is connected to the jetting device 20 via a carrier pipe 13 that carries the mixed ceramic powder P3 using a carrier gas G1 (to be described below), and can deliver the mixed ceramic powder P3 to the jetting device 20 along with the carrier gas G1.

As the raw ceramic powder P1 contained in the mixer 11, for example, a powder whose average particle size is smaller than or equal to 10 μm can be used. Furthermore, the raw ceramic powder P1 may be a powder whose average particle size ranges from 10 nm to 10 μm. As the raw ceramic powder P1, for example, yttria-stabilized zirconia (ZrO2-8 wt. % Y₂O₃), aluminum oxide (alumina), silica, titanium oxide (titania), or a mixture thereof may be used.

The additive P2 is formed of a material including an organic compound that imparts lubricity to the raw ceramic powder P1. As the additive P2, for example, an additive having an average particle size that is smaller than or equal to that of the raw ceramic powder P1 can be used. Furthermore, as the additive P2, for example, an additive whose average particle size is smaller than or equal to 10 nm can be used. As the additive P2, for example, an additive in which a globular ceramic powder (for example, globular silica) is coated with an organic compound (for example, phenylsilane) having a phenyl group by a coupling reaction can be used. The aforementioned “average particle size” is a value when an integration % of particle size distribution measured by a laser diffraction type particle size distribution measurement method is 50% (a median diameter of D50).

Here, in the case where the raw ceramic powder P1 is yttria-stabilized zirconia and the additive P2 contains globular silica, allowable strain of the formed coating varies depending on a percentage at which the globular silica is included. For this reason, a percentage occupied by the additive P2 in the mixed ceramic powder P3 need only be set to a percentage at which the allowable strain of the coating is not less than interfacial strain between a base material B and a coating formed on the base material B.

FIG. 2 is a graph illustrating adhesive forces of the raw ceramic powder P1 and the mixed ceramic powder P3 in the first embodiment of this invention.

In FIG. 2, the vertical axis indicates an adhesive force. Of two bar graphs illustrated in FIG. 2, the left bar graph is the raw ceramic powder P1, and the right bar graph is the mixed ceramic powder P3. “Adhesive force” is synonymous with ease of cohesion. The mixed ceramic powder P3 in FIG. 2 is that in which the added amount of the additive P2 is 1 wt %. The additive P2 is added to the raw ceramic powder P1, and thereby the adhesive force can be reduced by about 20% to 30%.

As illustrated in FIG. 1, the carrier gas supply unit 12 supplies the carrier gas G1 for sending the mixed ceramic powder P3 to the jetting device 20. The carrier gas supply unit 12 exemplified in the first embodiment is connected to the powder supply device 10 via a pipe 14 that forms a carrier gas flow passage. As the carrier gas G1 of the carrier gas supply unit 12, the same gas as a working gas G2 (to be described below) can be used, and for example, helium, nitrogen, air, or a mixture thereof can be used.

The jetting device 20 jets the mixed ceramic powder P3 toward a surface of the base material B. To be more specific, the jetting device 20 includes an acceleration nozzle such as a de Laval nozzle. The jetting device 20 is adopted such that the working gas is supplied from a working gas supply source (not shown). The jetting device 20 can accelerate the working gas G2, for example, to a supersonic velocity or the like using the acceleration nozzle. The jetting device 20 joins the mixed ceramic powder P3 with the accelerated working gas G2, and jets the mixed ceramic powder P3 along with the working gas G2.

The heating device 30 heats the mixed ceramic powder P3 jetted from the jetting device 20, and evaporates only an organic compound (an organic compound coating) of the additive P2 included in the mixed ceramic powder P3. Various types of heating devices 30 can be used as the heating device 30, such as a type in which a powder is heated by an arc or plasma. Here, evaporation of the raw ceramic powder P1 and the globular ceramic powder included in the additive P2 starts at a lower temperature than that of the organic compound coating of the globular ceramic powder. For this reason, a temperature to which the mixed ceramic powder P3 is heated by the heating device 30 is lower than that at which evaporation of the raw ceramic powder P1 and the globular ceramic powder starts, and need only be set to a temperature which is higher than a boiling point of the organic compound coating and at which the organic compound coating can be evaporated. It can be said that the temperature at which the organic compound coating can be evaporated is a temperature at which the organic compound coating can be removed from the mixed ceramic powder P3 by evaporating the organic compound coating.

A ceramic powder P4 from which the organic compound of the additive P2 is evaporated by passing through the heating device 30 collides with the base material B at a high speed, and thereby forms a ceramic coating C on the base material B.

The coating apparatus 100 in the first embodiment has the aforementioned constitution. Next, a coating method using the coating apparatus 100 will be described with reference to the drawings.

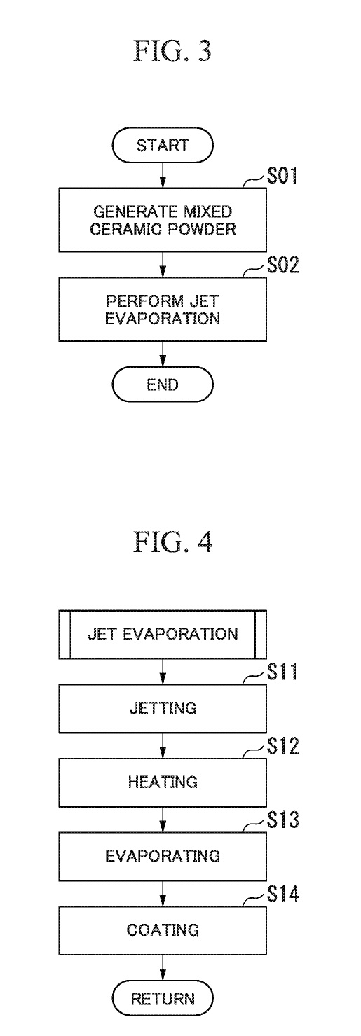

FIG. 3 is flow chart of a coating method in the first embodiment of this invention.

As illustrated in FIG. 3, first, a mixed ceramic powder-generating process (step S01) is performed. In the mixed ceramic powder-generating process, the raw ceramic powder P1 whose average particle size is less than or equal to 10 μm is put into the aforementioned mixer 11, and the additive P2 containing the organic compound imparting lubricity is put into the mixer 11. The raw ceramic powder P1 and the additive P2 are mixed to generate the mixed ceramic powder P3. Here, the additive P2 may be input little by little while visually checking the occurrence of cohesion. Afterward, the mixed ceramic powder P3 is delivered to the jetting device 20 using the carrier gas G1 supplied from the carrier gas supply unit 12.

Next, a jet evaporating process (step S02) is performed. In the jet evaporating process, the mixed ceramic powder P3 is jetted toward the surface of the base material B at a high speed, and the jetted mixed ceramic powder P3 is heated to evaporate the organic compound contained in the additive P2. In this case, the carrier gas G1 that carries the mixed ceramic powder P3 is joined to the working gas G2 for jetting the mixed ceramic powder P3 from a nozzle of the jetting device 20.

The mixed ceramic powder P3 is jetted from the nozzle of the jetting device 20 by the working gas G2 after the carrier gas G1 is joined. The mixed ceramic powder P3 is heated by the heating device 30 simultaneously with or directly after the jetting, and the organic compound contained in the additive P2 is evaporated and removed. Here, vapor of the evaporated organic compound may be discharged from a discharge port (not shown) or the like that is provided separately from a jet orifice of the nozzle.

Afterward, a ceramic powder P4 from which the organic compound is evaporated and removed collides with the base material B to generate a coating C.

FIG. 4 is a flow chart illustrating details of a jet evaporating process in the first embodiment of this invention.

The aforementioned jet evaporating process (step S02) includes four processes (steps S11 to S14) of FIG. 4. In step S11, the mixed ceramic powder P3 is jetted toward the surface of the base material B. In step S12, the jetted mixed ceramic powder P3 is heated before it reaches the base material B. In step S13, the organic compound contained in the additive P2 of the mixed ceramic powder P3 is evaporated and removed before the mixed ceramic powder P3 reaches the base material B. In step S14, the mixed ceramic powder P3 from which the organic compound contained in the additive P2 is removed collides with the base material B to form a coating.

Therefore, according to the coating apparatus and the coating method of the first embodiment described above, in the case where the raw ceramic powder P1 whose average particle size is smaller than or equal to 10 μm is used, the lubricity can be imparted to the raw ceramic powder P1 by the additive P2. For this reason, the cohesion of the mixed ceramic powder P3 in which the additive P2 is mixed into the raw ceramic powder P1 can be inhibited. For this reason, cohesion of a powder occurring in the inside or the like of the carrier pipe 13 between the mixer 11 and the jetting device 20 and causing, for example, stoppage of the apparatus can be inhibited.

Furthermore, only the organic compound of the additive P2 contained in the mixed ceramic powder P3 jetted from the jetting device 20 can be evaporated by the heating device 30. For this reason, the organic compound can be inhibited from being contained in the ceramic coating formed on the surface of the base material B.

As a result, the quality of the coating can be improved while inhibiting the cohesion of the raw ceramic powder P1.

Further, by setting the average particle size of the additive P2 to 10 nm or smaller, the additive P2 can be made sufficiently smaller than the raw ceramic powder P1. For this reason, the lubricity imparted by the additive P2 can be further improved.

Furthermore, in the case where the raw ceramic powder P1 contains at least yttria-stabilized zirconia, the coating C containing the yttria-stabilized zirconia can be densely formed to improve quality.

Moreover, phenylsilane is surface-treated on globular silica by a coupling reaction, and thereby lubricity can be imparted to the globular silica by the phenylsilane. Furthermore, since the phenylsilane is formed on a surface of the globular silica, a percentage at which phenylsilane is contained in the additive P2 can be made smaller than the case where the entire additive P2 is phenylsilane. As a result, the additive P2 can be easily evaporated by the heating device 30.

### EXAMPLES

Next, examples based on the aforementioned coating method will be described.

### Example 1

1 wt % additive (Admanano YA010C-SP3, available from Admatechs Co. Ltd.) whose average particle size was 10 nm and in which a phenyl group was treated on a surface of globular silica by silane coupling was mixed into a raw ceramic powder P1 of yttria-stabilized zirconia whose average particle size was 3.0 μm, and a mixed ceramic powder P3 was prepared.

Argon gas acting as a carrier gas carried the mixed ceramic powder P3, and was jetted by a jet heating device (RF-12040 (a high-frequency power supply), RF-56000 (a power supply operation panel), and RF-34041 (an automatic matching device)) that used the argon gas as a working gas. In this case, simultaneously with the jetting, the mixed ceramic powder P3 was heated to range from 400° C. or higher to 1000° C. or lower, and only phenylsilane was evaporated without melting the yttria-stabilized zirconia or the globular silica. A ceramic powder P4 from which the phenylsilane was evaporated collided with a base material B with a thermal barrier coating, and a coating formed mainly of yttria-stabilized zirconia was formed on the thermal barrier coating.

Afterward, a cross section of the coating formed on the base material B was observed with a scanning electron microscope (JXA-8230, available from JEOL Ltd.), and a percentage of visible impurities contained in the coating was measured.

### Example 2

1 wt % additive (Admanano YA010C-SP3, available from Admatechs Co. Ltd.) whose average particle size was 10 nm and in which a phenyl group was treated on a surface of globular silica by silane coupling was mixed into a raw ceramic powder P1 of yttria-stabilized zirconia whose average particle size was 1.4 μm, and a mixed ceramic powder P3 was prepared.

Argon gas acting as a carrier gas carried the mixed ceramic powder P3, and was jetted by a jet heating device (RF-12040 (a high-frequency power supply), RF-56000 (a power supply operation panel), and RF-34041 (an automatic matching device)) that used the argon gas as a working gas. In this case, simultaneously with the jetting, the mixed ceramic powder P3 was heated to range from 400° C. or higher to 1000° C. or lower, and phenylsilane was evaporated without melting the yttria-stabilized zirconia or the globular silica. A ceramic powder P4 from which the phenylsilane was evaporated collided with a base material B with a thermal barrier coating, and a coating formed mainly of yttria-stabilized zirconia was formed on the thermal barrier coating.

Afterward, a cross section of the coating formed on the base material B was observed with a scanning electron microscope (JXA-8230, available from JEOL Ltd.), and a percentage of visible impurities contained in the coating was measured.

### Example 3

1 wt. % additive (Admanano YA010C-SP3, available from Admatechs Co. Ltd.) whose average particle size was 10 nm and in which a phenyl group was treated on a surface of globular silica by silane coupling was mixed into a raw ceramic powder P1 of mullite whose average particle size was 10.0 μm, and a mixed ceramic powder P3 was prepared.

Argon gas acting as a carrier gas carried the mixed ceramic powder P3, and was jetted by a jet heating device (RF-12040 (a high-frequency power supply), RF-56000 (a power supply operation panel), and RF-34041 (an automatic matching device)) that used the argon gas as a working gas. In this case, simultaneously with the jetting, the mixed ceramic powder P3 was heated to range from 400° C. or higher to 1000° C. or lower, and phenylsilane was evaporated without melting the yttria-stabilized zirconia or the globular silica. A ceramic powder P4 from which the phenylsilane was evaporated collided with a base material B with a thermal barrier coating, and a coating formed mainly of yttria-stabilized zirconia was formed on the thermal barrier coating.

Afterward, a cross section of the coating formed on the base material B was observed with a scanning electron microscope (JXA-8230, available from JEOL Ltd.), and a percentage of visible impurities contained in the coating was measured.

### Example 4

1 wt. % additive (Admanano YA010C-SM1, available from Admatechs Co. Ltd.) whose average particle size was 10 nm and in which a methacrylic group was treated on a surface of globular silica by coupling was mixed into a raw ceramic powder P1 of yttria-stabilized zirconia whose average particle size was 3.0 μm, and a mixed ceramic powder P3 was prepared.

Argon gas acting as a carrier gas carried the mixed ceramic powder P3, and was jetted by a jet heating device (RF-12040 (a high-frequency power supply), RF-56000 (a power supply operation panel), and RF-34041 (an automatic matching device)) that used the argon gas as a working gas. In this case, simultaneously with the jetting, the mixed ceramic powder P3 was heated to range from 400° C. or higher to 1000° C. or lower, and an organic compound of the surface was evaporated without melting the yttria-stabilized zirconia or the globular silica. A ceramic powder P4 from which the organic compound of the surface was evaporated collided with a base material B with a thermal barrier coating, and a coating formed mainly of yttria-stabilized zirconia was formed on the thermal barrier coating.

Afterward, a cross section of the coating formed on the base material B was observed with a scanning electron microscope (JXA-8230, available from JEOL Ltd.), and a percentage of visible impurities contained in the coating was measured.

### Example 5

1 wt. % additive (Admanano YA010C-SV1, available from Admatechs Co. Ltd.) whose average particle size was 10 nm and in which a vinyl group was treated on a surface of globular silica by coupling was mixed into a raw ceramic powder P1 of yttria-stabilized zirconia whose average particle size was 3.0 μm, and a mixed ceramic powder P3 was prepared.

Argon gas acting as a carrier gas carried the mixed ceramic powder P3, and was jetted by a jet heating device (RF-12040 (a high-frequency power supply), RF-56000 (a power supply operation panel), and RF-34041 (an automatic matching device)) that used the argon gas as a working gas. In this case, simultaneously with the jetting, the mixed ceramic powder P3 was heated to range from 400° C. or higher to 1000° C. or lower, and an organic compound of the surface was evaporated without melting the yttria-stabilized zirconia or the globular silica. A ceramic powder P4 from which the organic compound of the surface was evaporated collided with a base material B with a thermal barrier coating, and a coating formed mainly of yttria-stabilized zirconia was formed on the thermal barrier coating.

Afterward, a cross section of the coating formed on the base material B was observed with a scanning electron microscope (JXA-8230, available from JEOL Ltd.), and a percentage of visible impurities contained in the coating was measured.

(Cohesive Property)

In Examples 1 to 5, when the coating was continuously formed, the mixed ceramic powder P3 did not cohere, a good carried state was maintained, and the coating could be continuously formed.

(Quality of Coating)

In Examples 1 to 5, when the cross section of the coating formed on the thermal barrier coating was observed, a dense ceramic coating whose porosity was less than 1% was confirmed.

That is, in Examples 1 to 5, both the cohesive property and the quality of the coating were good.

### Second Embodiment

Next, a second embodiment of this invention will be described. In the second embodiment, the case where a range of the additive rate of the additive P2 of the first embodiment described above depends on interfacial strain will be given as an example. For this reason, in the description of the second embodiment, the same portions as in the first embodiment are given the same reference signs, and detailed description overlapping with that of the first embodiment will be omitted.

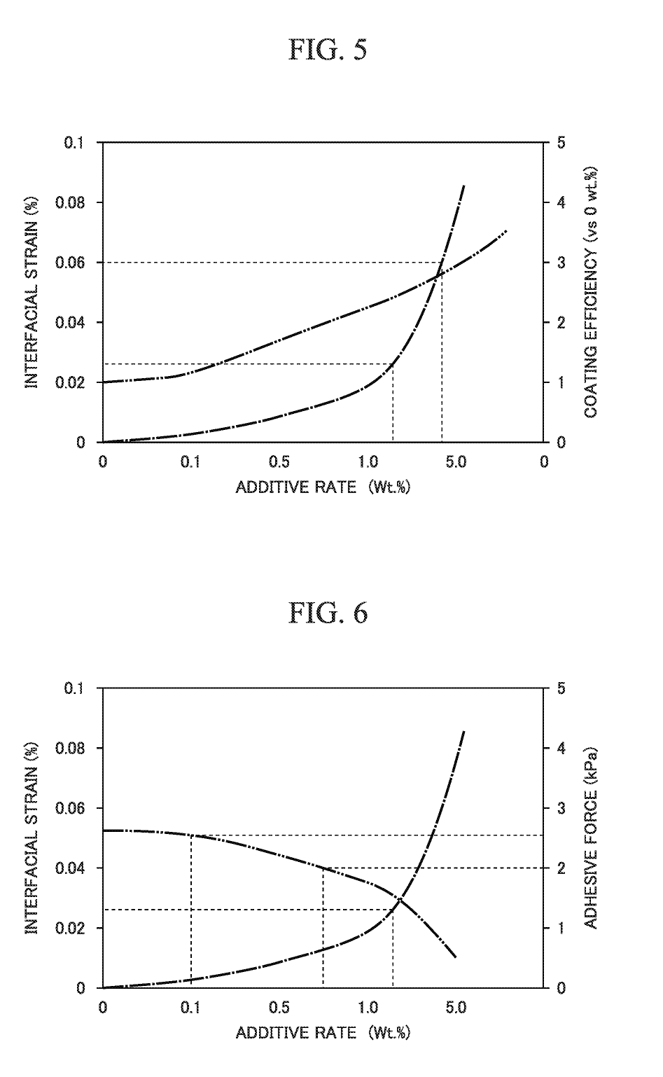

FIG. 5 is a graph whose vertical axes indicate interfacial strain (%) and coating efficiency (vs 0 wt. %) and whose horizontal axis indicates an additive rate (wt. %) of the additive added to the mixed ceramic powder.

As in the first embodiment, the “interfacial strain” shown in FIG. 5 is strain that occurs at an interface between a base material B (see FIG. 1) and a coating C (see FIG. 1) formed on the base material B. When occurrence strain of the coating C is defined as “εf,” and occurrence strain of a surface layer of the base material B is defined as “εs,” interfacial strain “εi” can be expressed by Equation (1) below.

εi=εf−εs=ΔT(αf−αs) (1)

Here, “αf” is a linear expansion coefficient (1/K) of the coating C, and “αs” is a linear expansion coefficient (1/K) of the surface layer of the base material B. “AT” is an amount of change in a temperature (for example, from room temperature to about 700° C.) within a usage environment temperature of the coating C.

The linear expansion coefficient of the coating C can be expressed by Equation (2) below.

αf=αaX+αs(1−X) (2)

Here, “αa” is a linear expansion coefficient (1/K) of the additive P2, and “X” is an additive rate (%) of the additive P2.

As illustrated in FIG. 5, when the additive rate of the additive P2 is increased from 0 (wt. %) with respect to the mixed ceramic powder P3, the interfacial strain (indicated by an alternate long and short dash line in FIG. 5) increases gradually. The interfacial strain serves as an index of quality (durability) of the coating. When the interfacial strain exceeds an allowable value, the coating C is peeled off from the base material B, and is not formed.

The coating efficiency (vs 0 wt. %, and indicated by an alternate long and two short dashes line in FIG. 5) increases as the additive rate of the additive P2 to the mixed ceramic powder P3 increases from 0 (wt. %). “Coating efficiency” refers to a rate of a coating speed based on a coating speed of the raw ceramic powder P1 (in other words, to which the additive P2 is not added). If the coating efficiency is improved, productivity of the coating C is also improved.

For example, in the case where the allowable strain is set to 0.060% as an allowable range of the quality (durability) of the coating C, the additive rate of the additive P2 becomes 3.80 wt. % or lower. Here, the allowable strain is an upper limit of the interfacial strain. The allowable strain value of 0.060% is a value obtained by a heat cycle durability test, and is an upper limit of the allowable strain which can inhibit the coating C from being peeled off to an allowable extent.

In the case where the allowable strain is set to 0.023%, the additive rate of the additive P2 becomes 1.31 wt. % or lower. The allowable strain value of 0.023% is also a value obtained by the heat cycle durability test. The allowable strain of 0.023% is an upper limit of the allowable strain for preventing the coating from being peeled off. In other words, the value is an upper limit of the range of the interfacial strain which makes the quality (durability) of the coating C more reliable.

For example, if the additive rate of the additive P2 (silica whose particle size is 10 nm) to the raw ceramic powder P1 (whose average particle size is 3 μm) is set to 3.80 wt. % or lower, the coating efficiency can be improved, and the quality (durability) of the coating C can be set within an allowable range.

Furthermore, the additive rate of the additive P2 (silica whose particle size is 10 nm) to the raw ceramic powder P1 (whose average particle size is 3 μm) is set to 0.75 wt. % or higher and 1.31 wt. % or lower, and thereby the quality (durability) of the coating C can be made more reliable while securing a two-fold or more coating efficiency.

Next, a third embodiment of this invention will be described. In the third embodiment, the case where the range of the additive rate of the additive P2 of the first embodiment described above depends on a relationship between the interfacial strain and the adhesive force will be given as an example. For this reason, in the description of the third embodiment, the same portions as in the first embodiment are given the same reference signs, and detailed description overlapping with that of the first embodiment will be omitted.

FIG. 6 is a graph whose vertical axes indicate interfacial strain (%) and adhesive force (kPa) and whose horizontal axis indicates an additive rate (wt. %) of the additive added to the mixed ceramic powder.

Here, as in the first embodiment, “adhesive force” shown in FIG. 6 (indicated by an alternate long and two short dashes line in FIG. 6) is an adhesive force in the mixed ceramic powder P3, and is synonymous with ease of cohesion of the mixed ceramic powder P3. “Interfacial strain” can be obtained in the same way as in the second embodiment described above.

The interfacial strain shown in FIG. 6 (indicated by an alternate long and short dash line in FIG. 6) is the same as the interfacial strain shown in FIG. 5. That is, when the additive rate of the additive P2 is increased from 0 (wt. %) with respect to the mixed ceramic powder P3, the interfacial strain increases gradually. The interfacial strain serves as the index of the quality (durability) of the coating. When the interfacial strain exceeds an allowable value, the coating C is peeled off from the base material B, and is not formed.

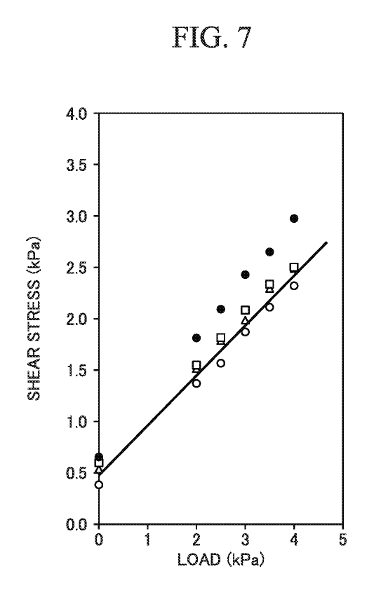

FIG. 7 is a graph whose vertical axis indicates shear stress (kPa) and whose horizontal axis is a load (kPa). In the graph of FIG. 7, ●, □, Δ, and ◯ indicate mixed ceramic powders P3 in which the additive rates of the additives P2 are different. A relationship between the additive rates of the additives P2 to these mixed ceramic powders P3 is ●<□<Δ<◯.

As illustrated in FIG. 7, as a load applied to the mixed ceramic powder P3 is increased from 0 (kPa), shear stress (kPa) acting on the mixed ceramic powder P3 also increases. In other words, the shear stress is substantially in proportion to the load applied to the mixed ceramic powder P3. Further, as the additive rate of the additive P2 to the mixed ceramic powder P3 increases, the shear stress is reduced. The shear stress when the load is 0 (kPa) is equivalent to the adhesive force. That is, as illustrated in FIGS. 6 and 7, as the additive rate of the additive P2 becomes high, the adhesive force (kPa) becomes low, and fluidity of the mixed ceramic powder P3 becomes high. The adhesive force serves as the index of the cohesive property of the powder. A range under a solid line indicated in the graph of FIG. 7 shows an example of a range in which there is fluidity in the mixed ceramic powder P3 and no pulsation occurs. If the additive rate of the additive P2 in which the shear stress is lower than the solid line of FIG. 7 is selected, the mixed ceramic powder P3 can be inhibited from cohering inside the apparatus.

For example, in the case where an upper limit of the adhesive force (hereinafter referred to as allowable adhesive force) is 2.5 kPa in order to set the occurrence of a phenomenon such as clogging or pulsation in the apparatus within an allowable range, the additive rate of the additive P2 is 0.1 wt. % or higher.

Further, in the case where the allowable adhesive force is 2.0 kPa in order to secure a reliable supply more without causing the phenomenon such as clogging or pulsation in the apparatus, the additive rate of the additive P2 is 0.75 wt. % or higher.

For example, if the additive rate of the additive P2 (silica whose particle size is 10 nm) to the raw ceramic powder P1 (whose average particle size is 3 μm) is set to 0.10 wt. % or higher, the cohesion of the mixed ceramic powder P3 is inhibited, and the occurrence of the phenomenon such as clogging or pulsation in the apparatus resulting from low fluidity of the mixed ceramic powder P3 can be set within the allowable range.

Further, if the additive rate of the additive P2 to the raw ceramic powder P1 is set to 0.75 wt. % or higher (adhesive force of 2 kPa or lower) and 1.31 wt. % or lower (interfacial strain of 0.023% or lower), the supply stability of the mixed ceramic powder P3 can be secured without the occurrence of the phenomenon such as clogging or pulsation in the apparatus resulting from low fluidity of the mixed ceramic powder P3. In addition, since the interfacial strain can be inhibited, conditions of the quality (durability) of the coating C can be satisfied more reliably.

This invention is not limited to the constitution of each of the aforementioned embodiments, and enables a change in design without departing from the gist or teaching thereof.

For example, the case where the coating is formed by the cold spray method has been described in each of the aforementioned embodiments, but the present invention is not limited thereto. For example, other cold spray methods such as an aerosol deposition method, a powder jet deposition method, and so on may be applied.

Further, in each of the aforementioned embodiments, a coating method performed without melting the raw ceramic powder P1 has been described by way of example, but the raw ceramic powder P1 may be slightly melted.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10 Powder supply device
11 Mixer
12 Carrier gas supply unit
13 Carrier pipe
14 Pipe
20 Jetting device
30 Heating device
P1 Raw ceramic powder
P2 Additive
P3 Mixed ceramic powder
G1 Carrier gas
G2 Working gas
B Base material
C Coating

What is claimed is:

1. A coating apparatus, comprising:
a mixer configured to generate a mixed ceramic powder in which a material containing an organic compound that imparts lubricity to a raw ceramic powder whose average particle size is smaller than or equal to 10 μm and acting as an additive is mixed into the raw ceramic powder;
a jetting device configured to jet the mixed ceramic powder toward a surface of a base material; and
a heating device configured to heat the mixed ceramic powder jetted from the jetting device, and to evaporate the organic compound of the additive contained in the mixed ceramic powder.

2. The coating apparatus according to claim 1, wherein the heating device heats the mixed ceramic powder jetted toward the surface of the base material by the jetting device before the jetted mixed ceramic powder reaches the surface of the base material, and evaporates the organic compound of the additive contained in the mixed ceramic powder.

3. The coating apparatus according to claim 1, wherein an average particle size of the additive is smaller than or equal to 10 nm.

4. The coating apparatus according to claim 3, wherein the raw ceramic powder contains at least yttria-stabilized zirconia.

5. The coating apparatus according to claim 3, wherein the additive contains globular silica and the organic compound provided on a surface of the globular silica.

6. The coating apparatus according to claim 5, wherein:
the organic compound is phenylsilane; and
the additive is formed by surface-treating the phenylsilane on the globular silica through a coupling reaction.

7. A coating method, comprising:
a mixed ceramic powder-generating process of mixing a material containing an organic compound that imparts lubricity and acting as an additive into a raw ceramic powder whose average particle size is smaller than or equal to 10 μm to generate a mixed ceramic powder; and
a jet evaporating process of jetting the mixed ceramic powder toward a surface of a base material, and heating the jetted mixed ceramic powder to evaporate the organic compound contained in the additive.

8. The coating method according to claim 7, wherein the raw ceramic powder contains at least yttria-stabilized zirconia.

9. The coating method according to claim 7, wherein the additive contains globular silica and the organic compound provided on a surface of the globular silica.

10. The coating method according to claim 9, wherein:
the organic compound is phenylsilane; and
the additive is formed by surface-treating the phenylsilane on the globular silica through a coupling reaction.

11. A coating method, comprising:
mixing a material containing an organic compound that imparts lubricity and acting as an additive into a raw ceramic powder whose average particle size is smaller than or equal to 10 μm to generate a mixed ceramic powder;
jetting the mixed ceramic powder toward a surface of a base material;
heating the jetted mixed ceramic powder before the jetted mixed ceramic powder reaches the base material;
evaporating and removing the organic compound contained in the additive of the mixed ceramic powder before the mixed ceramic powder reaches the base material; and
causing the mixed ceramic powder from which the organic compound is removed to collide with the base material to form a coating.

12. The coating apparatus according to claim 4, wherein the additive contains globular silica and the organic compound provided on a surface of the globular silica.

13. The coating apparatus according to claim 12, wherein:
the organic compound is phenylsilane; and
the additive is formed by surface-treating the phenylsilane on the globular silica through a coupling reaction.

14. The coating apparatus according to claim 8, wherein the additive contains globular silica and the organic compound provided on a surface of the globular silica.

15. The coating apparatus according to claim 14, wherein:
the organic compound is phenylsilane; and
the additive is formed by surface-treating the phenylsilane on the globular silica through a coupling reaction.
